(19) United States
(12) Patent Application Publication
(10) Pub. No.: US 2012/0069209 A1
(43) Pub. Date: Mar. 22, 2012

(54) LENSLESS CAMERA CONTROLLED VIA MEMS ARRAY

(75) Inventors: Sauri Gudlavalleti, Machilipatnam (IN); Manish Kothari, Cupertino, CA (US)

(73) Assignee: Qualcomm MEMS Technologies, Inc.

(21) Appl. No.: 12/888,092

(22) Filed: Sep. 22, 2010

(51) Int. Cl. H04N 5/335; H04N 5/228

(52) U.S. Cl. 348/222.1; 348/294; 348/E05.031; 348/E05.091

(57) ABSTRACT

A lensless camera may include an array of MEMS-based light-modulating devices. A camera controller may control the MEMS-based light-modulating devices to transmit visible light through, or substantially prevent the transmission of visible light through, predetermined areas of the array. The array may be controlled in response to input from a user and/or in response to the location of a detected subject. The viewing direction of a lensless camera having such an array can be rapidly changed by changing the transmittance of different regions of the array.

### FIELD OF THE INVENTION

This application relates generally to lensless cameras.

### BACKGROUND OF THE INVENTION

Lensless cameras, sometime referred to as “pinhole” cameras, can be manufactured at a low cost, in part because the lens is eliminated. Lensless cameras do not need to be focused and can be made durable and easy to use. Pinhole cameras are often used for surveillance.

However, conventional lensless cameras have a number of drawbacks. For example, in order to change the field of view of a conventional lensless camera, the distance between the aperture and the detector can be changed. Moving the detector closer to the pinhole (or vice versa) will result in a wider field of view. Moving the detector farther away from the pinhole will result in a narrower field of view. Such movement is conventionally implemented by a motor, which adds cost and complexity to the lensless camera. Various hardware and software solutions have been implemented to mitigate such problems, but no solution has proven to be entirely satisfactory.

### SUMMARY

Some embodiments comprise an array that includes microelectromechanical systems (“MEMS”)-based light-modulating devices. The array may be configured to absorb and/or reflect light when in a first configuration and to transmit light when in a second position. Such devices may have a fixed optical stack on a substantially transparent substrate and a movable mechanical stack disposed at a predetermined air gap from the fixed stack. The optical stacks are chosen such that when the movable stack is “up” or separated from the fixed stack, most light entering the substrates passes through the two stacks and air gap. When the movable stack is down, or close to the fixed stack, the combined stack allows only a negligible amount of light to pass through.

According to some embodiments, a lensless camera may include an array of such MEMS-based light-modulating devices. A camera controller may control the MEMS-based light-modulating devices to transmit light through, or substantially prevent the transmission of light through, predetermined areas of the array. In some embodiments, the array may be controlled in response to input from a user, in response to the location of a detected subject, etc. For example, the viewing direction of a lensless camera having such an array can be rapidly changed by changing the transmittance of different regions of the array. Accordingly, there is no need to use a pan/tilt motor such as those in some conventional cameras.

According to some such embodiments, the MEMS devices in a group may be gang-driven instead of being individually controlled. In such embodiments, the camera flash system may comprise a simple and relatively inexpensive controller for this purpose, as compared with a controller that is configured to individually control each MEMS device in the array.

Some implementations described herein provide a lensless camera that includes a light sensor, an interface configured to receive a field of view indication an array of microelectromechanical systems (“MEMS”) devices and a control system. The MEMS array may be configured to block incoming visible light from reaching the light sensor when the MEMS devices are in a first position and to transmit incoming visible light to the light sensor when the MEMS devices are in a second position. The control system may be configured to do the following: receive a field of view indication from the interface; determine a transmissive area in the array of MEMS devices corresponding with the field of view indication; control MEMS devices in the transmissive area to be in the second position; and drive other MEMS devices of the array to the first position.

In some implementations of the lensless camera, the interface may be a user interface. Alternatively, or additionally, the interface may be a network interface. The control system may be configured to control the lensless camera, at least in part, according to signals received via the network interface and/or the user interface.

The lensless camera may include a display device. The control system may be further configured to control the display device to display image data from the light sensor. The display device may be part of a user interface. The control system may be further configured to control the display device to indicate a current field of view.

The control system may be further configured to receive subject identification data from the interface and to control the array to track a subject according to the subject identification data. The subject identification data may include image data from a portion of an image displayed on a display device of the lensless camera. The control system may be configured to analyze image data received by the light sensor to determine whether the image data indicate possible subjects.

In some lensless camera implementations wherein the interface includes a network interface, the subject identification data may include image data from a portion of an image displayed on an operator's display device. The operator's display device may be configured for communication with the lensless camera via the network interface.

A mobile device may include the lensless camera. The mobile device may, for example, be configured for data and voice communication.

The control system may be further configured to indicate possible subjects on a display of the lensless camera. The control system may be further configured to receive a user's selection, from a user interface of the lensless camera, of one of the possible subjects indicated on the display. The control system may control a touch screen display of the lensless camera to indicate the possible subjects.

Alternative lensless cameras are described herein. Some such lensless cameras include a light-sensing apparatus, an interface configured to receive a field of view indication, an array apparatus and a control apparatus. The array apparatus may be configured for blocking incoming visible light from reaching the light-sensing apparatus when the array apparatus is in a first configuration and to transmit incoming visible light to the light-sensing apparatus when the array apparatus is in a second configuration. The control apparatus may be configured for the following functions: receiving a field of view indication from the interface apparatus; determining a transmissive area in the array apparatus corresponding with the field of view indication; controlling MEMS devices in the transmissive area to be in the second configuration; and driving other MEMS devices of the array apparatus to the first configuration.

The interface apparatus may include a user interface and/or a network interface. The control apparatus may be configured to control the lensless camera, at least in part, according to signals received via the network interface and/or the user interface. The control apparatus may be further configured to receive subject identification data from the interface apparatus and to control the array apparatus to track a subject according to the subject identification data.

Various methods are described herein. Some such methods include the following processes: receiving a field of view indication for a lensless camera; determining a pinhole location for the lensless camera corresponding with the field of view indication; controlling an array of micro electromechanical systems (“MEMS”) devices to form a transmissive area in an array location corresponding to the pinhole location and to make the remaining MEMS devices of the array substantially non-transmissive in the visible spectrum; and capturing an image from light passing through the transmissive area.

The receiving process may involve receiving the field of view indication from a user interface of the lensless camera. Alternatively, or additionally, the receiving process may involve receiving the field of view indication from a network interface of the lensless camera. The method may involve controlling a display to indicate a current field of view.

The method may also involve receiving subject identification data and controlling the array to track a subject according to the subject identification data. The method may also involve analyzing image data received during the capturing process and determining whether the image data indicate possible subjects. The method may include indicating the possible subjects on a display.

These and other methods of the invention may be implemented by various types of devices, systems, components, software, firmware, etc. For example, some features of the invention may be implemented, at least in part, by computer programs embodied in machine-readable media. Some such computer programs may, for example, include instructions for determining which areas of the array will be substantially transmissive and which areas will be substantially non-transmissive.

### BRIEF DESCRIPTION OF THE DRAWINGS

FIGS. 1A and 1B depict a simplified version of a MEMS-based light-modulating device configured to absorb and/or reflect light when in a first position and to transmit light when in a second position.

FIG. 1C is an isometric view depicting a portion of one embodiment of an interferometric modulator array in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator array.

FIG. 3 is a diagram of movable mirror position versus applied voltage for one embodiment of an interferometric modulator such as those depicted FIG. 1C.

FIG. 4 is an illustration of a set of row and column voltages that may be used to drive an interferometric modulator array.

FIG. 5A illustrates one configuration of the 3×3 interferometric modulator array of FIG. 2.

FIG. 5B illustrates an example of a timing diagram for row and column signals that may be used to cause the configuration of FIG. 5A.

FIG. 6A is a schematic cross-section of an embodiment of an electrostatically actuatable modulator device comprising two or more conductive layers.

FIG. 6B is a plot of the transmission and reflection of the modulator device of FIG. 6A as a function of wavelength for two air gap heights.

FIG. 6C is a schematic cross-section of an embodiment comprising a modulator device and an additional device.

FIG. 7A depicts an array of MEMS-based light-modulating devices in a closed position.

FIG. 7B depicts the array of MEMS devices of FIG. 7A, some of which are in a closed position and some of which are in an open position.

FIG. 7C depicts an array of MEMS devices in another configuration.

FIG. 7D depicts an array of MEMS devices in an alternative configuration.

FIG. 8A depicts a MEMS array in a first configuration for capturing images from a first field of view.

FIG. 8B depicts the MEMS array in a second configuration for capturing images from a second field of view.

FIG. 8C depicts the first MEMS array in a third configuration for capturing images from a third field of view.

FIG. 9 is a block diagram that depicts some components of a lensless camera controlled via a MEMS array.

FIG. 10A is a front view of a display device having a lensless camera as described herein.

FIG. 10B is a back view of a display device having a lensless camera as described herein.

FIG. 10C is a block diagram that illustrates components of a display device such as that shown in FIGS. 10A and 10B.

FIG. 11 is a flow chart that outlines steps of some methods described herein.

FIG. 12 is a flow chart that outlines steps of alternative methods described herein.

### DETAILED DESCRIPTION

While the present invention will be described with reference to a few specific embodiments, the description and specific embodiments are merely illustrative of the invention and are not to be construed as limiting. Various modifications can be made to the described embodiments. For example, the steps of methods shown and described herein are not necessarily performed in the order indicated. It should also be understood that the methods shown and described herein may include more or fewer steps than are indicated. In some implementations, steps described herein as separate steps may be combined. Conversely, what may be described herein as a single step may be implemented as multiple steps.

Similarly, device functionality may be apportioned by grouping or dividing tasks in any convenient fashion. For example, when steps are described herein as being performed by a single device (e.g., by a single logic device), the steps may alternatively be performed by multiple devices and vice versa.

MEMS interferometric modulator devices may include a pair of reflective layers positioned at a variable and controllable distance from each other to form a resonant optical gap with at least one variable dimension. This gap may be sometimes referred to herein as an “air gap,” although gases or liquids other than air may occupy the gap in some embodiments. Some embodiments comprise an array that includes MEMS-based light-modulating devices. The array may be configured to absorb and/or reflect light when in a first configuration and to transmit light when in a second position.

According to some embodiments described herein, a lensless camera may include a camera controller, an image sensor and an array that includes such MEMS devices. The camera controller may control the array to transmit light through at least one “pinhole” of a predetermined size and in a predetermined location of the array. The camera controller may control the array to substantially prevent the transmission of light through other areas of the array. In some embodiments, the array may be controlled in response to input from a user. Alternatively, or additionally, the array may be controlled in response to the location of a detected subject.

The field of view of some such lensless cameras can be rapidly changed by changing the transmittance of different regions of the array. For example, the camera flash system may control the array to “track” a detected subject and allow light from the subject to reach the image sensor via transmissive pinholes formed in a succession of locations of the array. Accordingly, there is no need to use a pan/tilt motor, such as those in some conventional lensless cameras, to change the field of view.

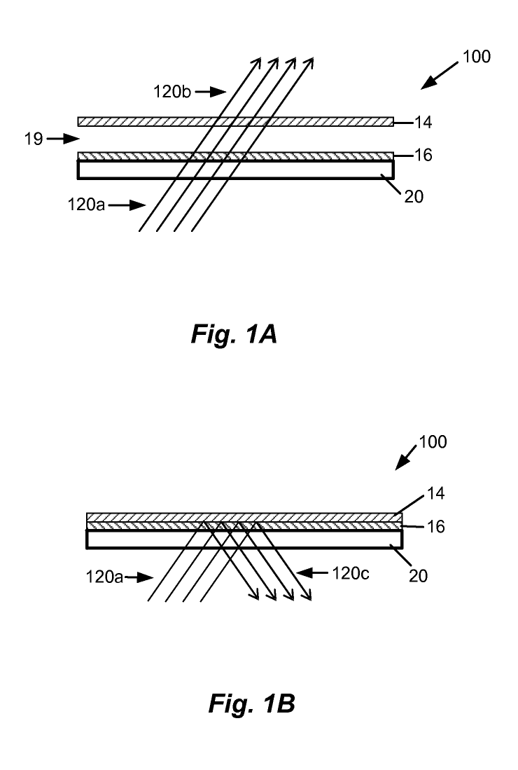

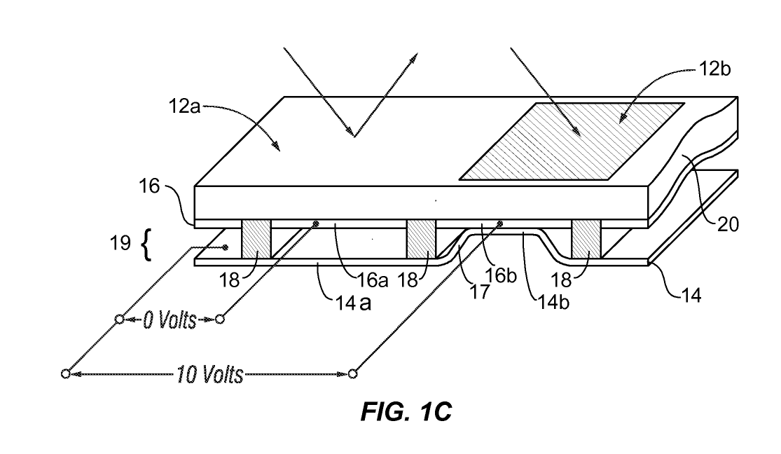

A simplified example of a MEMS-based light-modulating device that may form part of such an array is depicted in FIGS. 1A and 1B. In this example, MEMS interferometric modulator device 100 includes fixed optical stack 16 that has been formed on substantially transparent substrate 20. Movable reflective layer 14 may be disposed at a predetermined gap 19 from the fixed stack.

In some embodiments, movable reflective layer 14 may be moved between two positions. In the first position, which may be referred to herein as a relaxed position, the movable reflective layer 14 is positioned at a relatively large distance from a fixed partially reflective layer. The relaxed position is depicted in FIG. 1A. In the second position, referred to herein as the actuated position, the movable reflective layer is positioned more closely adjacent to the partially reflective layer. Alternative embodiments may be configured in a range of intermediate positions between the actuated position and the relaxed position.

The optical stacks may be chosen such that when the movable stack 14 is “up” or separated from the fixed stack 16, most visible light 120a that is incident upon substantially transparent substrate 20 passes through the two stacks and air gap. Such transmitted light 120b is depicted in FIG. 1A. However, when the movable stack 14 is down, or close to the fixed stack 16, the combined stack allows only a negligible amount of visible light to pass through. In the example depicted in FIG. 1B, most visible light 120a that is incident upon substantially transparent substrate 20 re-emerges from substantially transparent substrate 20 as reflected light 120b.

Depending on the embodiment, the light reflectance properties of the “up” and “down” states may be reversed. MEMS pixels and/or subpixels can be configured to reflect predominantly at selected colors, in addition to black and white. Moreover, in some embodiments, at least some visible light 120a that is incident upon substantially transparent substrate 20 may be absorbed. In some such embodiments, MEMS device 100 may be configured to absorb most visible light 120a that is incident upon substantially transparent substrate 20 and/or configured to partially absorb and partially transmit such light. Some such embodiments are discussed below.

FIG. 1C is an isometric view depicting two adjacent subpixels in a series of subpixels, wherein each subpixel comprises a MEMS interferometric modulator. In some embodiments, a MEMS array comprises a row/column array of such subpixels. Incident light that reflects from the two layers interferes constructively or destructively depending on the position of the movable reflective layer, producing either an overall reflective or non-reflective state for each subpixel or subpixel.

The depicted portion of the subpixel array in FIG. 1C includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

In some embodiments, the optical stacks 16a and 16b (collectively referred to as optical stack 16) may comprise several fused layers, which can include an electrode layer, such as indium tin oxide (ITO), a partially reflective layer, such as chromium, and a transparent dielectric. The optical stack 16 is thus electrically conductive, partially transparent, and partially reflective. The optical stack 16 may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row or column electrodes. For example, the movable reflective layers 14a, 14b may be formed as a series of parallel strips of a deposited metal layer or layers (which may be substantially orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a MEMS array.

With no applied voltage, the gap 19 remains between the movable reflective layer 14a and optical stack 16a, with the movable reflective layer 14a in a mechanically relaxed state, as illustrated by the subpixel 12a in FIG. 1C. However, when a potential difference is applied to a selected row and column, the capacitor formed at the intersection of the row and column electrodes at the corresponding subpixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by subpixel 12b on the right in FIG. 1C. The behavior may be the same regardless of the polarity of the applied potential difference.

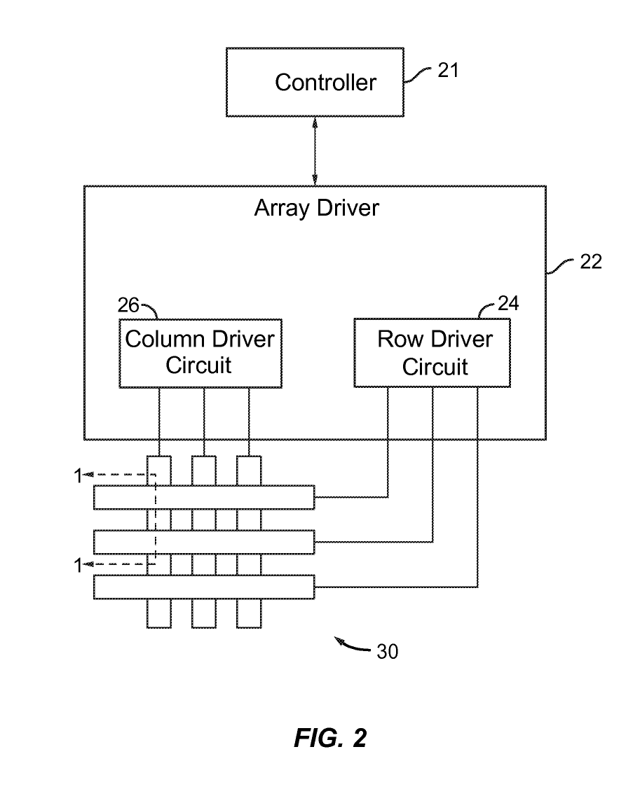

FIGS. 2 through 5B illustrate examples of processes and systems for using an array of interferometric modulators.

FIG. 2 is a system block diagram illustrating one embodiment of an electronic device that may incorporate aspects of the invention. In the exemplary embodiment, the electronic device includes a controller 21 which may comprise one or more suitable general purpose single- or multi-chip microprocessors such as an ARM, Pentium®, Pentium II®, Pentium III®, Pentium IVO, Pentium® Pro, an 8051, a MIPS®, a Power PC®, an ALPHA®, and/or any suitable special purpose logic device such as a digital signal processor, an application-specific integrated circuit (“ASIC”), a microcontroller, a programmable gate array, etc. The controller 21 may be configured to execute one or more software modules. In addition to executing an operating system, controller 21 may be configured to execute one or more software applications, such as software for executing methods described herein or any other software application.

In one embodiment, the controller 21 is also configured to communicate with an array driver 22. In one embodiment, the array driver 22 includes a row driver circuit 24 and a column driver circuit 26 that provide signals to an array or panel 30, which is a MEMS array in this example. The cross section of the MEMS array illustrated in FIG. 1C is shown by the lines 1-1 in FIG. 2.

The row/column actuation protocol may take advantage of a hysteresis property of MEMS interferometric modulators that is illustrated in FIG. 3. It may require, for example, a 10 volt potential difference to cause a movable layer to deform from the relaxed state to the actuated state. However, when the voltage is reduced from that value, the movable layer can maintain its state as the voltage drops back below 10 volts. In the example of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.”

For a MEMS array having the hysteresis characteristics of FIG. 3, the row/column actuation protocol can be designed such that during row strobing, subpixels in the strobed row that are to be actuated are exposed to a voltage difference of about 10 volts, and subpixels that are to be relaxed are exposed to a voltage difference of close to zero volts. After the strobe, the subpixels are exposed to a steady state voltage difference of about 5 volts such that they remain in whatever state the row strobe put them in. After being driven, each subpixel sees a potential difference within the “stability window” of 3-7 volts in this example.

This feature makes the subpixel design illustrated in FIG. 1C stable under the same applied voltage conditions in either an actuated or relaxed pre-existing state. Since each subpixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the subpixel if the applied potential is fixed.

Desired areas of a MEMS array may be controlled by asserting the set of column electrodes in accordance with the desired set of actuated subpixels in the first row. A row pulse may then be applied to the row 1 electrode, actuating the subpixels corresponding to the asserted column lines. The asserted set of column electrodes is then changed to correspond to the desired set of actuated subpixels in the second row. A pulse is then applied to the row 2 electrode, actuating the appropriate subpixels in row 2 in accordance with the asserted column electrodes. The row 1 subpixels are unaffected by the row 2 pulse, and remain in the state they were set to during the row 1 pulse. This may be repeated for the entire series of rows in a sequential fashion to produce the desired configuration.

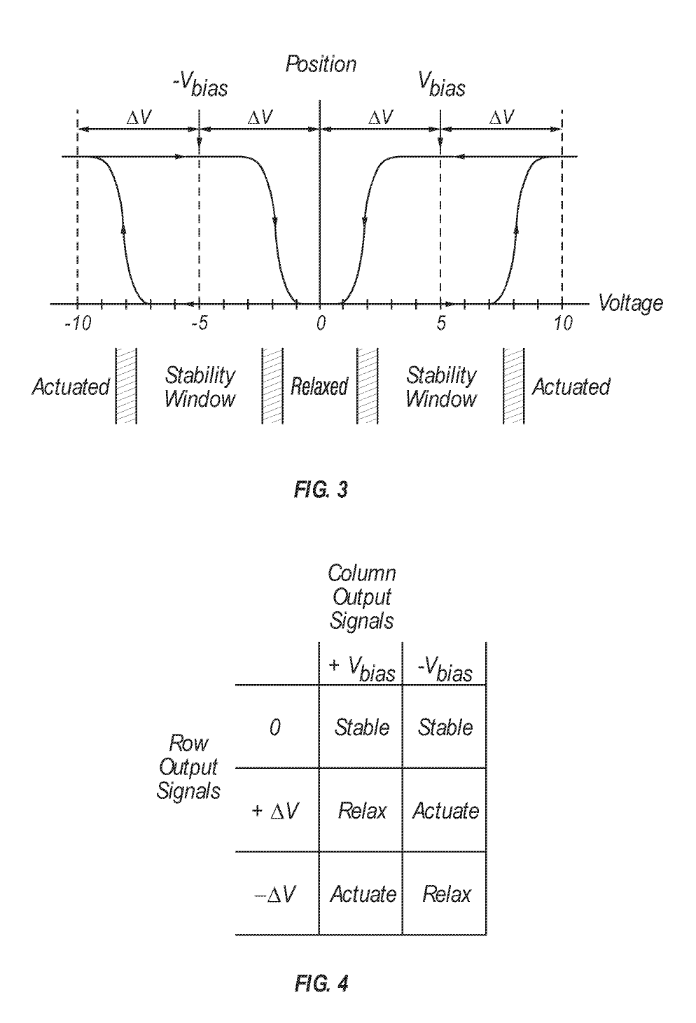

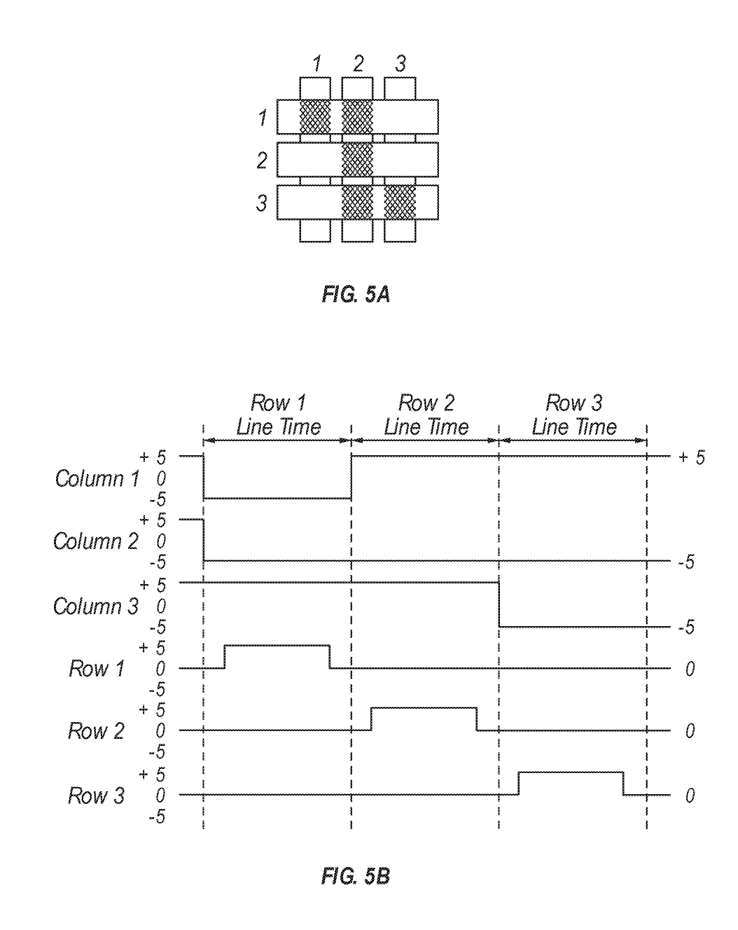

A wide variety of protocols for driving row and column electrodes of subpixel arrays may be used to control a MEMS array. FIGS. 4, 5A, and 5B illustrate one possible actuation protocol for controlling the 3×3 array of FIG. 2. FIG. 4 illustrates a possible set of column and row voltage levels that may be used for subpixels exhibiting the hysteresis curves of FIG. 3.

In the embodiment depicted in FIG. 4, actuating a subpixel involves setting the appropriate 5 column to −Vbias, and the appropriate row to +ΔV, which may correspond to −5 volts and +5 volts, respectively. Relaxing the subpixel is accomplished by setting the appropriate column to +Vbias, and the appropriate row to the same +ΔV, producing a zero volt potential difference across the subpixel. In those rows where the row voltage is held at zero volts, the subpixels are stable in whatever state they were originally in, regardless of whether the column is at +Vbias, or −Vbias. As is also illustrated in FIG. 4, it will be appreciated that voltages of opposite polarity than those described above can be used, e.g., actuating a subpixel can involve setting the appropriate column to +Vbias, and the appropriate row to −ΔV. In this embodiment, releasing the subpixel is accomplished by setting the appropriate column to −Vbias, and the appropriate row to the same −ΔV, producing a zero volt potential difference across the subpixel.

FIG. 5B is a timing diagram showing a series of row and column signals applied to the 3×3 array of FIG. 2 that will result in the arrangement illustrated in FIG. 5A, wherein actuated subpixels are non-reflective. Prior to being in the configuration illustrated in FIG. 5A, the subpixels can be in any state, and in this example, all the rows are at 0 volts, and all the columns are at +5 volts. With these applied voltages, all subpixels are stable in their existing actuated or relaxed states.

In the configuration depicted in FIG. 5A, subpixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any subpixels, because all the subpixels remain in the 3-7 volt stability window. Row 1 is then strobed with a pulse that goes from 0, up to 5 volts, and back to zero. This actuates the (1,1) and (1,2) subpixels and relaxes the (1,3) subpixel. No other subpixels in the array are affected. To set row 2 as desired, column 2 is set to −5 volts, and columns 1 and 3 are set to +5 volts. The same strobe applied to row 2 will then actuate subpixel (2,2) and relax subpixels (2,1) and (2,3). Again, no other subpixels of the array are affected. Row 3 is similarly set by setting columns 2 and 3 to −5 volts, and column 1 to +5 volts. The row 3 strobe sets the row 3 subpixels as shown in FIG. 5A. After writing the frame, the row potentials are zero, and the column potentials can remain at either +5 or −5 volts, and the array is then stable in the arrangement of FIG. 5A.

It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any suitable actuation voltage method can be used with the systems and methods described herein.

For example, in some camera-related embodiments described herein, groups of MEMS devices in predetermined areas of a MEMS array may be gang-driven instead of being individually controlled. These predetermined areas may, for example, comprise two or more groups of contiguous MEMS devices. A controller, such as a controller of a camera or of a camera flash system, may control the movable stack of each MEMS device in the group to be in substantially the same position (e.g., in the “up” or “down” position).

In some such embodiments, a camera may comprise a simple and relatively inexpensive controller for this purpose, as compared with a controller that is configured to individually control each MEMS device in the array. In some embodiments, the controller may control the array in response to input from a user, in response to detected ambient light conditions and/or in response to the location of a detected subject or other detected features.

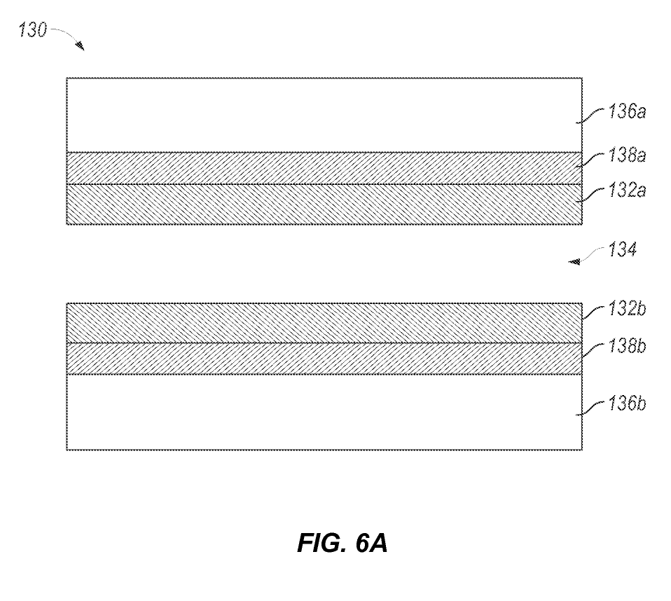

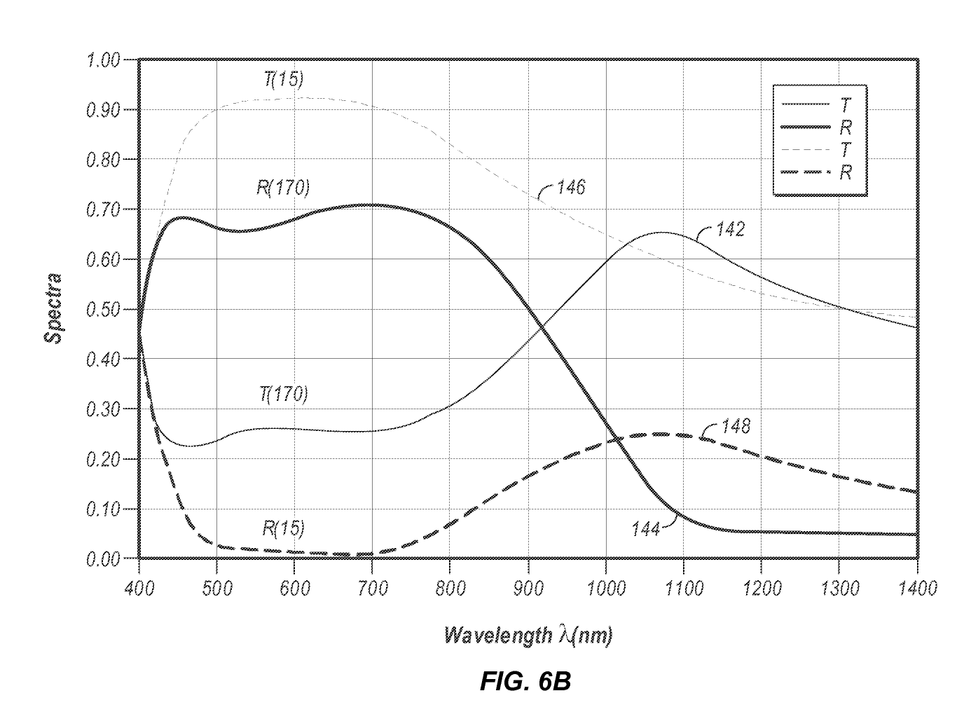

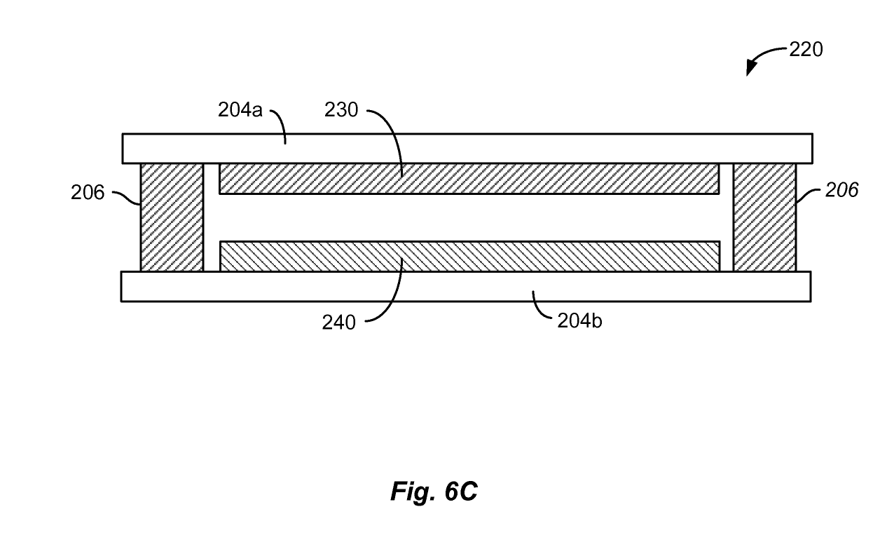

In some embodiments, a modulator device may include actuation elements integrated into the thin-film stack which permit displacement of portions of layers relative to one another so as to alter the spacing therebetween. FIG. 6A illustrates an exemplary modulator device 130 which is electrostatically actuatable. The device 130 includes a conductive layer 138a supported by a substrate 136a, and an optical layer 132a overlying the conductive layer 138a. Another conductive layer 138b is supported by substrate 136b and an optical layer 132b overlies the conductive layer 138b. The optical layer 132a and 132b are separated from one another by an air gap. Application of a voltage across conductive layers 138a and 138b will cause the one of the layers to deform towards the other one.

In some embodiments, the conductive layers 138a and 138b may comprise a transparent or light-transmissive material, such as indium tin oxide (ITO), for example, although other suitable materials may be used. The optical layers 132a and 132b may comprise a material having a high index of refraction. In some particular embodiments, the optical layers 132a and 132b may comprise titanium dioxide, although other materials may be used as well, such as lead oxide, zinc oxide, and zirconium dioxide, for example. The substrates may comprise glass, for example, and at least one of the substrates may be sufficiently thin to permit deformation of one of the layers towards the other.

In one embodiment in which the conductive layers 138a and 138b comprise ITO and are 80 nm in thickness, the optical layers 132a and 132b comprise titanium dioxide and are 40 nm in thickness, and the air gap is initially 170 nm in height. FIG. 6B illustrates plots across the visible and a portion of infrared wavelengths of the modeled transmission and reflectivity as a function of wavelength λ of the modulator device 130 both when the device is in an actuated state with an air gap of 15 nm and in an unactuated state with an air gap of 170 nm. The 15 nm air gap represents a fully actuated state, but surface roughness may in some embodiments prevent a further reduction in air gap size. In particular, line 142 illustrates the transmission as a function of wavelength when the device is in an unactuated position (T(170)), and line 144 illustrates the reflectivity in the same state (R(170)). Similarly, line 146 illustrates the transmission as a function of wavelength when the device is in an actuated position (T(15)), and line 148 illustrates the reflectivity in the actuated position (R(15)).

It can be seen from these plots that the modulator device 130 is highly transmissive across visible wavelengths when in an actuated state with a small air gap (15 nm), particularly for those wavelengths of less than about 800 nm. When in an unactuated state with a larger air gap (170 nm), the device becomes roughly 70% reflective to those same wavelengths. In contrast, the reflectivity and transmission of the higher wavelengths, such as infrared wavelengths, does not significantly change with actuation of the device. Thus, the modulator device 130 can be used to selectively alter the transmission/reflection of a wide range of visible wavelengths, without significantly altering the infrared transmission/reflection (if so desired).

FIG. 6C illustrates an embodiment of an apparatus 220, in which a first modulator device 230 is formed on a first substantially transparent substrate 204a, and a second device 240 is formed on a second substantially transparent substrate 204b. In one embodiment, the first modulator device 230 comprises a modulator device capable of switching between a state which is substantially transmissive to a wide range of visible radiation and another state in which the reflectance across a wide range of visible radiation is increased.

The second device 240 may in certain embodiments comprise a device which transmits a certain amount of incident light. In certain embodiments, the device 240 may comprise a device which absorbs a certain amount of incident light. In particular embodiments, the device 240 may be switchable between a first state which is substantially transmissive to incident light, and a second state in which the absorption of at least certain wavelengths is increased. In still other embodiment, the device 240 may comprise a fixed thin film stack having desired transmissive, reflective, or absorptive properties.

In certain embodiments, suspended particle devices (“SPDs”) may be used to change between a transmissive state and an absorptive state. These devices comprise suspended particles which in the absence of an applied electrical field are randomly positioned, so as to absorb and/or diffuse light and appear “hazy.” Upon application of an electrical field, these suspended particles may be aligned in a configuration which permits light to pass through.

Other devices 240 may have similar functionality. For example, in alternative embodiments, device 240 may comprise another type of “smart glass” device, such as an electrochromic device, micro-blinds or a liquid crystal device (“LCD”). Electrochromic devices change light transmission properties in response to changes in applied voltage. Some such devices may include reflective hydrides, which change from transparent to reflective when voltage is applied. Other electrochromic devices may comprise porous nano-crystalline films. In another embodiment, device 240 may comprise an interferometric modulator device having similar functionality.

Thus, when the device 240 comprises an SPD or a device having similar functionality, the apparatus 220 can be switched between three distinct states: a transmissive state, when both devices 230 and 240 are in a transmissive state, a reflective state, when device 230 is in a reflective state, and an absorptive state, when device 240 is in an absorptive state. Depending on the orientation of the apparatus 220 relative to the incident light, the device 230 may be in a transmissive state when the apparatus 220 is in an absorptive state, and similarly, the device 240 may be in a transmissive state when the apparatus 220 is in an absorptive state.

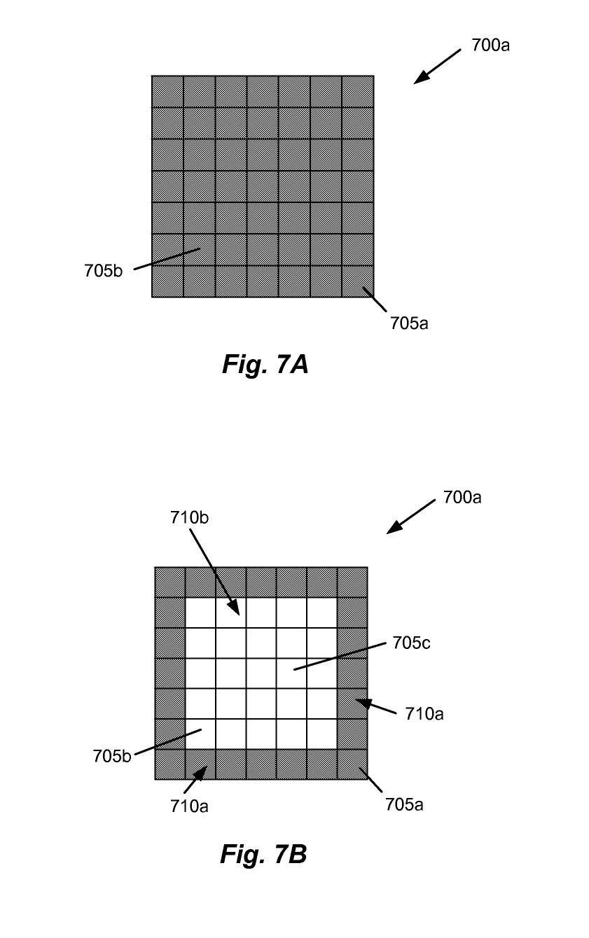

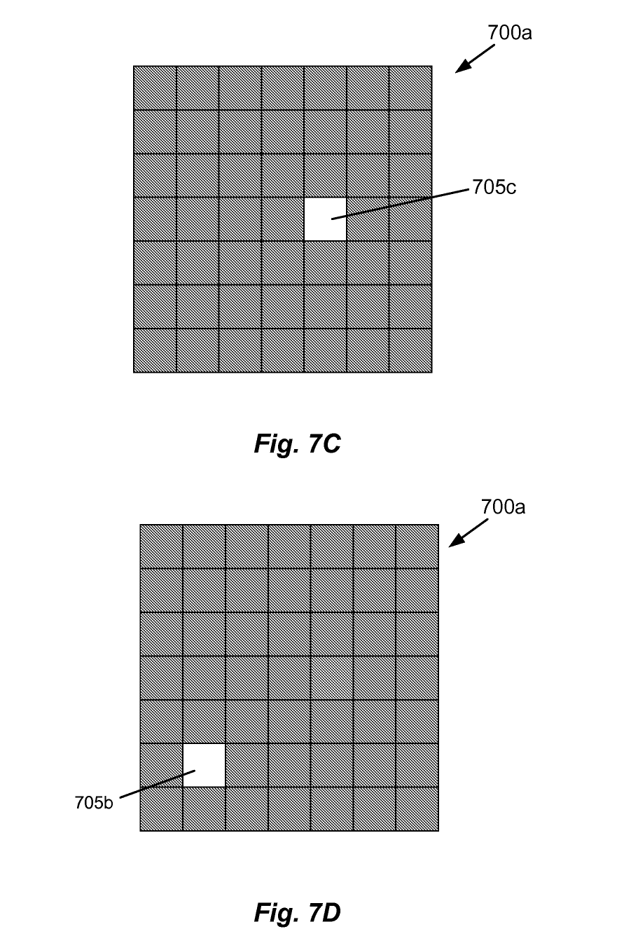

Arrays of MEMS devices that may be used for some embodiments described herein are depicted in FIGS. 7A-7D. Although such MEMS devices may be grouped into what may be referred to herein as a “MEMS array” or the like, some such MEMS arrays may include devices other than MEMS devices. For example, some MEMS arrays described herein may include non-MEMS devices, including but not limited to an SPD or a device having similar functionality, which is configured to selectively absorb or transmit light.

Referring first to FIG. 7A, MEMS array 700a is shown in a first configuration, in which MEMS array 700a is configured to block substantially all visible incident light. In this example, groups of individual MEMS devices of MEMS array 700a are controlled together. Here, each of cells 705 includes a plurality of individual MEMS devices (and possibly other devices, such as SPDs or devices having similar functionality), all of which are configured to be gang-driven by a controller. For example, each of the individual devices within cell 705a may be controlled as a group. Similarly, each of the individual devices within cell 705b will be controlled as a group.

Referring now to FIG. 7B, it will be observed that all of the cells within area 710a, including cell 705a, are being controlled to block substantially all visible incident light. However, all of the cells within area 710b, including cell 705b, are being controlled to transmit substantially all visible incident light. In this example, fewer than 50 individual cells need to be individually controlled. Although alternative embodiments may involve controlling more or fewer cells, controlling individual devices within each cell as a group can greatly simplify the control system required for controlling a MEMS array.

Further simplifications may be introduced in other embodiments, for example, by controlling an entire row, column or other aggregation of cells 705 as a group. In some such embodiments, all of the cells 705 within area 710a may be controlled as a group. In some such embodiments, the devices with area 710a and/or other portions of MEMS array 700a may be organized into separately controllable cells 705, but alternative embodiments may not comprise separately controllable cells 705. In some embodiments, columns and/or rows of devices and/or cells 705 may be controlled as a group.

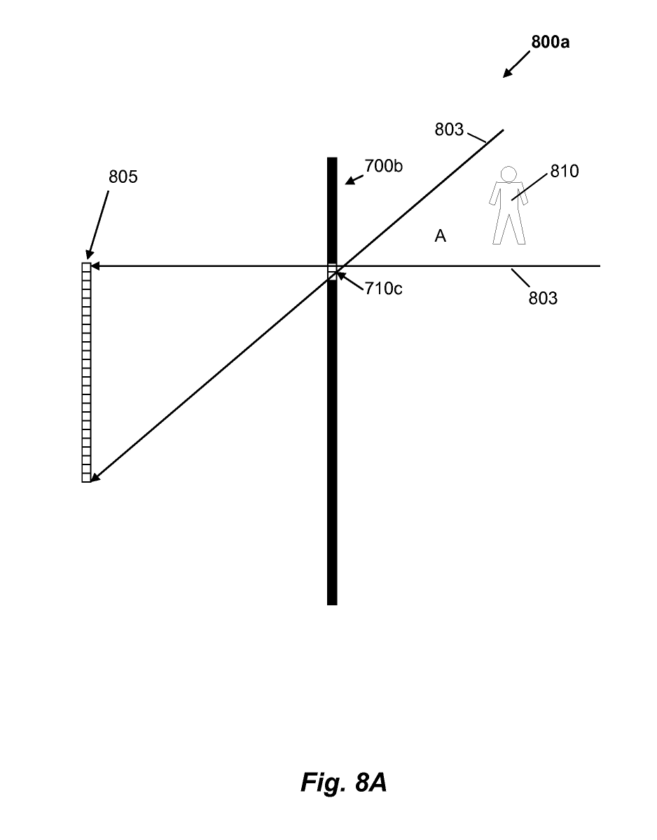

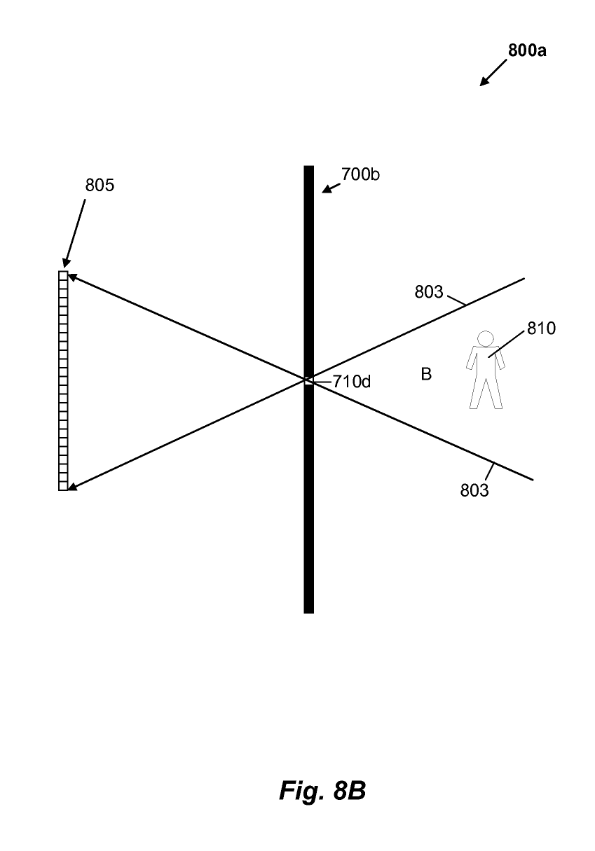

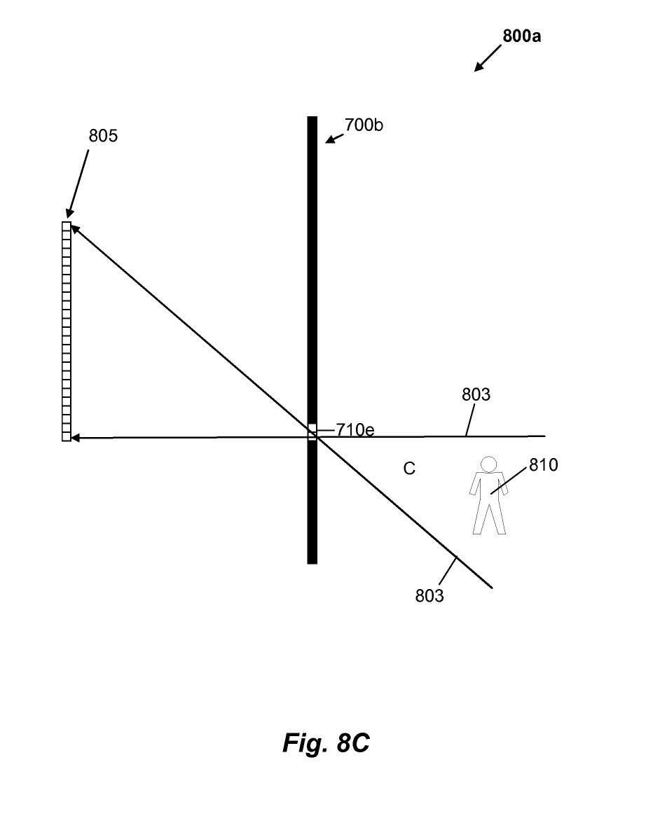

As with other drawings referenced herein, the dimensions of FIGS. 7C through 8C are not drawn to scale. For example, cells 705 are not drawn to scale. In FIGS. 8A through 8C, the relative sizes of subject 810, light sensor 805 and array 700b, as well as the distances between them, are not drawn to scale. Moreover, other embodiments of arrays 700a and 700b may have more or fewer cells.

In FIG. 7C, cell 705c being controlled to transmit visible incident light. All of the other cells within array 700a are being controlled to block substantially all visible incident light. Such a configuration may be used to implement a lensless camera, wherein cell 705c acts as the “pinhole” through which light enters the camera to produce an image on a light sensor. The size and location of the pinhole may be controlled by a camera controller or another such device. In some embodiments, the number and/or size(s) of the cells in an array may be dynamically reconfigured, e.g., according to predetermined settings. Commands and/or data regarding such settings may be stored in a memory accessible by a camera controller.

FIG. 7D depicts array 700a in another configuration. Here, all of the cells within array 700a, except cell 705b, are being controlled to block substantially all visible incident light. Here, cell 705b of array 700a can act as the pinhole through which light enters a lensless camera. Accordingly, the camera controller can readily change the location of the pinhole by controlling which area(s) of array 700a will or will not transmit light.

By changing the location of the pinhole, a camera controller can change the field of view of a lensless camera. The field of view may be altered without moving array 700a or the lensless camera's light sensor. This may be seen more easily with reference to FIGS. 8A through 8C.

FIG. 8A is a schematic diagram of some elements of a lensless camera 800a. Here, a camera controller (not shown) is controlling array 700b such that light passes only through transmissive area 710c. The camera controller is controlling other areas of array 700b to absorb and/or reflect substantially all incident visible light. In this configuration, light rays 803 can enter lensless camera 800a within field of view A. Accordingly, light that is reflected from subject 810 within field of view A may be received by light sensor 805.

FIG. 8B depicts lensless camera 800a and subject 810 at a time during which subject 810 is in a different position. Here, the camera controller is controlling area 710d to be in a substantially transmissive state and controlling the remaining areas of array 700b to absorb and/or reflect substantially all incident visible light. In this configuration, light rays 803 can enter lensless camera 800a within field of view B. Light reflected from subject 810 within field of view B may be received by light sensor 805. Similarly, in FIG. 8C, light rays 803 can enter lensless camera 800a via substantially transmissive area 710e. Therefore, light reflected from subject 810 within field of view C may be received by light sensor 805.

Accordingly, without changing the position of light sensor 805 or array 700b, camera 800b can track the location of subject 810 by selecting a sequence of transmissive areas 710 of array 700b through which light will be allowed to reach light sensor 805. Although FIGS. 8A through 8C appear to depict changing the field of view by selecting a sequence of transmissive areas 710 along an axis of array 700b that is within the plane of the drawing sheet, the sequence of transmissive areas 710 may be selected field of view may be changed along various trajectories, curved or straight, which may or may not be within the same plane. This fact is suggested, for example, by comparing FIG. 7C and FIG. 7D.

Because such tracking may be accomplished merely by selecting a sequence of transmissive areas 710 within array 700b, there is no need to use a pan/tilt motor (or the like) to obtain a desired field of view. However, in alternative embodiments of camera 800b, light sensor 805, array 700b or both may be movable, e.g., may be configured for rotation or translation. Moreover, some embodiments of camera 800b may be configured for mounting on a camera mount that can change the orientation of camera 800b. Such a configuration may be useful for implementing security or surveillance cameras, for example.

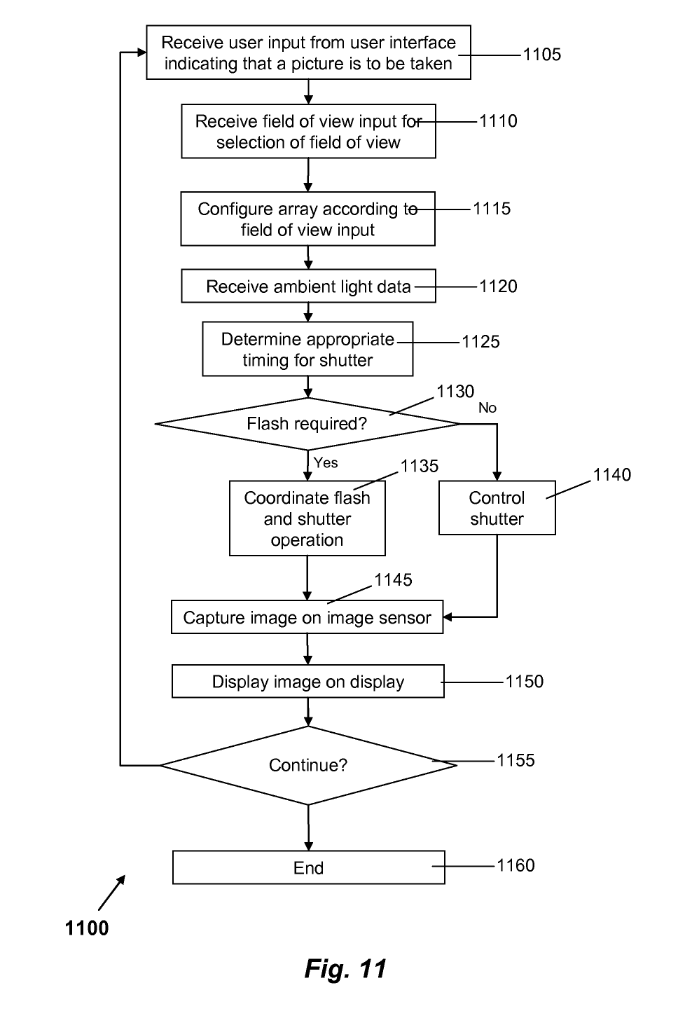

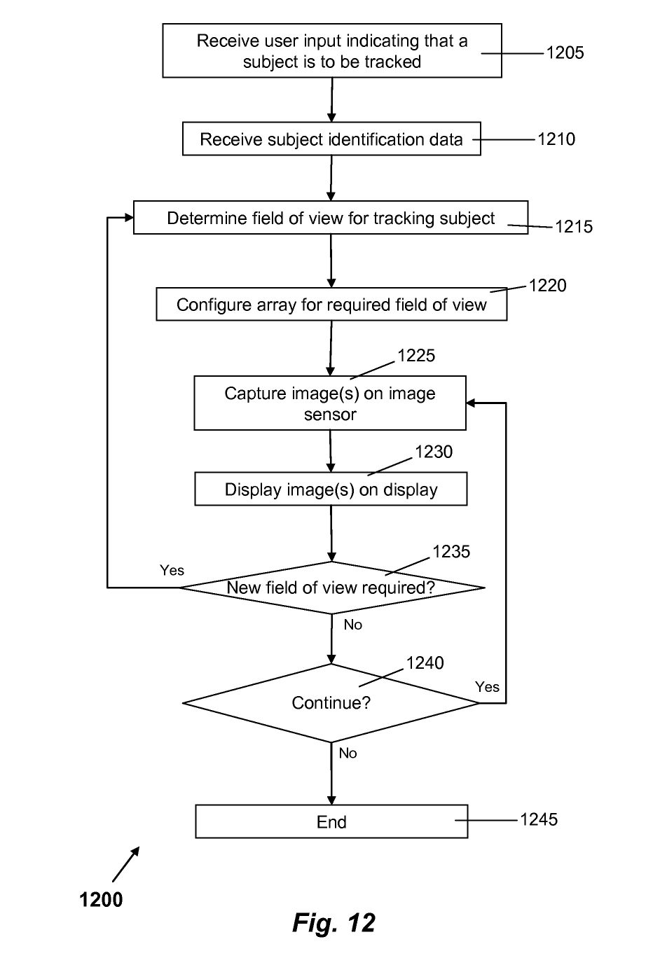

Some cameras 800b may be configured for automatic field of view control, whereas other cameras 800b may be configured for “manual” field of view control in response to user input. Still other cameras 800b may be configured to have the field of view controlled either automatically or manually, according to a user's selection. Relevant processes are described below with reference to FIGS. 11 and 12.

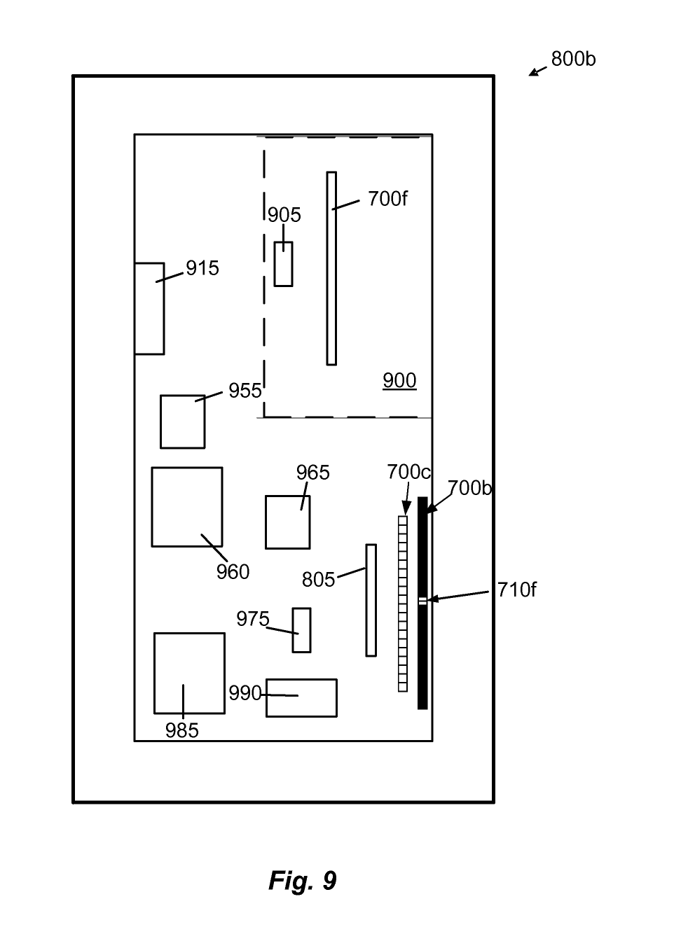

FIG. 9 is a block diagram that depicts components of a lensless camera 800b according to some embodiments described herein. Images conveyed by light that enters transmissive area 710f may be captured on image sensor 805. Because camera 800b does not require a lens, camera 800b can be controlled without the need for manual or automatic focusing.

Camera 800b includes camera controller 960, which may include one or more processors, logic devices, memory, etc. Camera controller 960 may be configured to control various components of camera 800b. For example, by controlling which area(s) of array 700b will be transmissive, camera controller 960 may control transmissive and non-transmissive areas of array 700b to determine one or more fields of view received by image sensor 805.

In some embodiments, user interface system 965 may include one or more buttons, switches, trackballs or similar devices. User interface system 965 may include a display device configured to display images, graphical user interfaces, etc. In some such embodiments, user interface system 965 may include a touch screen. User interface system 965 may have varying complexity, according to the specific embodiment.

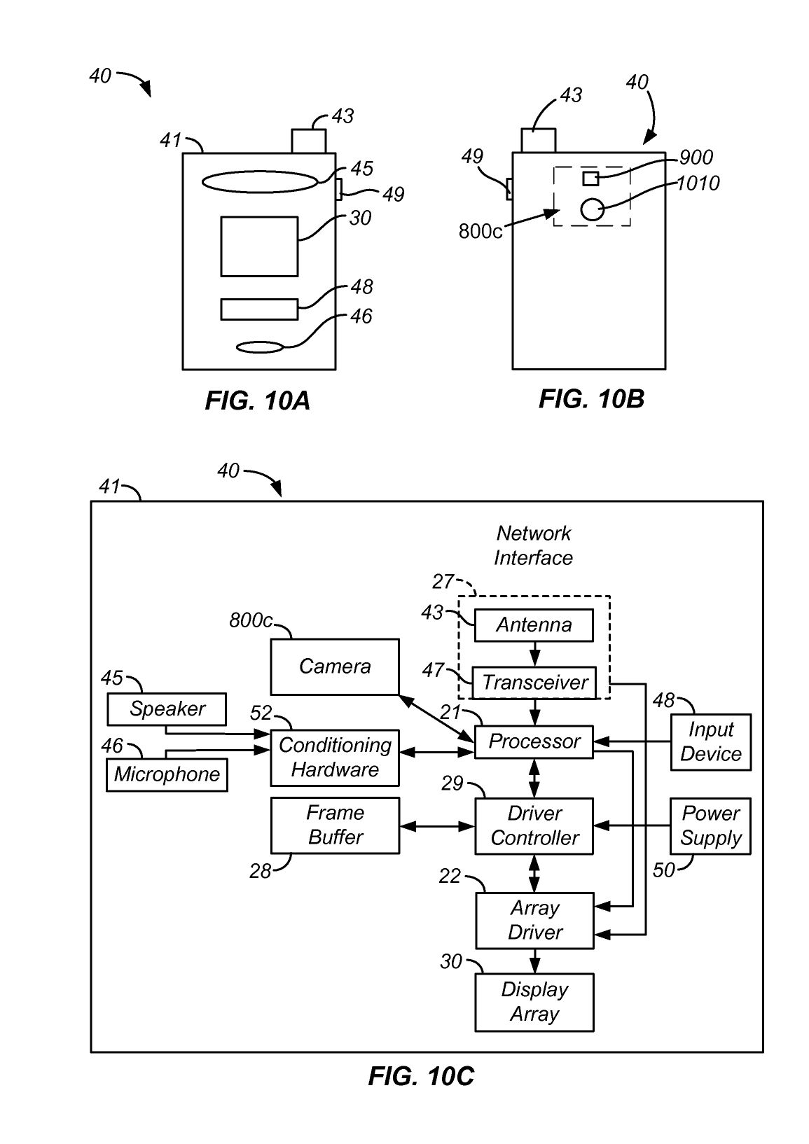

Camera controller 960 may control a display, such as that depicted in FIG. 10A, to display images captured on image sensor 805. The display may also be controlled to display graphical user interfaces, etc., and may comprise a touch screen. As such, the display may be regarded as part of user interface system 965. Data corresponding with such images may be stored in memory 985.

Camera controller 960 may control at least some components of camera 800b according to input from user interface system 965. For example, user interface system 965 may include a field of view user interface that allows a user to provide input to camera controller 960 to control the field of view provided by array 700b. In some such embodiments, a display device may indicate the field of view selected by the user. As described elsewhere herein, a user may be able to provide subject identification data regarding a subject that the user desires to have tracked automatically according to the control of array 700b by camera controller 960.

Camera controller 960 may be configured to control the shutter speed, shutter timing, etc., of shutter array 700c. In some embodiments, user interface system 965 may include a shutter control that allows a user to indicate a desired shutter speed. Camera controller 960 may also control shutter array 700c according to ambient light data received from light sensor 975. Various MEMS-based embodiments of shutter array 700c are described in U.S. application Ser. No. 12/843,716 (see, e.g., FIGS. 7A through 9, 11 and 12 and the corresponding description), entitled “MEMS-Based Aperture and Shutter (Attorney Docket No. QUALP024/100318U1) and filed on Jul. 26, 2010, which is hereby incorporated by reference. However, in alternative embodiments, camera 800b may include a conventional camera shutter.

Camera flash assembly 900 includes light source 905 and flash array 700f. In this embodiment, camera flash assembly 900 does not have a separate controller. Instead, camera controller 960 controls camera flash assembly 900 of camera 800b. Here, camera controller 960 is configured to send control signals to camera flash assembly 900 regarding the appropriate configuration of flash array 700f and/or the appropriate illumination provided by light source 905. Moreover, camera controller 960 may be configured to synchronize the operation of camera flash assembly 900 with the operation of shutter array 700c. Camera interface system 955 provides I/O functionality and transfers information between camera controller 960, camera flash assembly 900 and other components of camera 800b.

Various MEMS-based embodiments of camera flash assembly 900 are described in U.S. application Ser. No. 12/836,872 (see, e.g., FIGS. 7A through 9B, 11A and 11B and the corresponding description), entitled “Camera Flash System Controlled Via MEMS Array (Attorney Docket No. QUALP026/100318U2) and filed on July 15, 2010, which is hereby incorporated by reference. However, in alternative embodiments, camera 800b may include a conventional camera flash assembly 900 that does not include a MEMS-based array. Moreover, in alternative embodiments camera flash assembly 900 may also include a flash assembly controller configured for controlling light source 905 and/or array 700f.

In this embodiment, camera 800b includes network interface 915. Network interface 915 may be configured for wireless and/or wired communication, depending on the particular implementation. In some embodiments, network interface 915 may comprise a receiver and/or transmitter configured for radio frequency (“RF”) communication, such as that described below with reference to FIG. 10C. In alternative embodiments, network interface 915 may comprise a receiver and/or transmitter configured for infrared (“IR”) communication. Such a network interface 915 may be configured to receive data or commands from a remote control device, to transmit data or commands to or to receive data or commands from another device that operates in the IR band. For example, such a network interface 915 may be configured to receive data or commands from a remote control device that operates in the IR band.

In some embodiments, network interface 915 may comprise an interface such as a Universal Serial Bus (“USB”) interface or another such interface that is configured for physical, wired connection with another device. In some such embodiments, camera 800a may be configured to receive power and/or recharge battery 990 via network interface 915.

In some embodiments, such as those described below with reference to FIGS. 10A through 10C, camera 800b may be part of a device that has its own network interface. In such embodiments, it may not be necessary for camera 800b to have a separate network interface 915.

However, in alternative embodiments, camera 800b may not be part of another device. For example, camera 800b may be a surveillance camera, a webcam or a hand-held camera intended for personal use by a consumer. (If camera 800b is a surveillance camera or a webcam, camera 800b may or may not include flash system 900.) In such embodiments, camera 800b may be configured to receive commands via network interface 915 for the control of one or more elements, such as array 700b. In this manner, the field of view of camera 800b may be remotely controlled, at least in part. For example, camera 800b may be remotely controlled via commands from an operator's device that are transmitted to camera 800b over a network and received via network interface 915. The operator's device may, for example, be a laptop computer, a desktop computer, a mobile device such as a smartphone or iPad™, etc.

FIGS. 10A-10C are system block diagrams illustrating an embodiment of a display device 40 that includes a lensless camera as provided herein. The display device 40 may be, for example, a portable device such as a cellular or mobile telephone, a personal digital assistant (“PDA”), etc. However, the same components of display device 40 or slight variations thereof are also illustrative of various types of display devices such as portable media players.

Referring now to FIG. 10A, a front side of display device 40 is shown. This example of display device 40 includes a housing 41, a display 30, an antenna 43, a speaker 45, an input system 48, a shutter control 49 and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 in this example of the display device 40 may be any of a variety of displays. Moreover, although only one display 30 is illustrated in FIG. 10A, display device 40 may include more than one display 30. For example, the display 30 may comprise a flat-panel display, such as plasma, an electroluminescent (EL) display, a light-emitting diode (LED) (e.g., organic light-emitting diode (OLED)), a transmissive display such as a liquid crystal display (LCD), a bi-stable display, etc. Alternatively, display 30 may comprise a non-flat-panel display, such as a cathode ray tube (CRT) or other tube device, as is well known to those of skill in the art. However, for the embodiments of primary interest in this application, the display 30 includes at least one transmissive display.

FIG. 10B illustrates a rear side of display device 40. In this example, lensless camera 800c is disposed on an upper portion of the rear side of display device 40. Here, camera flash assembly 900 is disposed above substantially transparent area 1010, through which light may enter lensless camera 800c via a transmissive area 710 of an array 700. Such other elements of lensless camera 800c are disposed within housing 41 and are not visible in FIG. 10B.

Components of one embodiment of display device 40 are schematically illustrated in FIG. 2. The illustrated display device 40 includes a housing 41 and can include additional components at least partially enclosed therein. For example, in one embodiment, the display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input system 48 and a driver controller 29. The driver controller 29 is coupled to a frame buffer 28 and to an array driver 22, which in turn is coupled to a display array 30. A power supply 50 provides power to all components as required by the particular display device 40 design.

The network interface 27 includes the antenna 43 and the transceiver 47 so that the display device 40 can communicate with one or more devices over a network. In some embodiments, the network interface 27 may also have some processing capabilities to relieve requirements of the processor 21. The antenna 43 may be any antenna known to those of skill in the art for transmitting and receiving signals. In one embodiment, the antenna is configured to transmit and receive RF signals according to an Institute of Electrical and Electronics Engineers (IEEE) 802.11 standard, e.g., IEEE 802.11(a), (b), or (g). In another embodiment, the antenna is configured to transmit and receive RF signals according to the BLUETOOTH standard. In the case of a cellular telephone, the antenna may be designed to receive Code Division Multiple Access (“CDMA”), Global System for Mobile communications (“GSM”), Advanced Mobile Phone System (“AMPS”) or other known signals that are used to communicate within a wireless cell phone network. The transceiver 47 may pre-process the signals received from the antenna 43 so that the signals may be received by, and further manipulated by, the processor 21. The transceiver 47 may also process signals received from the processor 21 so that the signals may be transmitted from the display device 40 via the antenna 43.

In an alternative embodiment, the transceiver 47 may be replaced by a receiver and/or a transmitter. In yet another alternative embodiment, network interface 27 may be replaced by an image source, which may store and/or generate image data to be sent to the processor 21. For example, the image source may be a digital video disk (DVD) or a hard disk drive that contains image data, or a software module that generates image data. Such an image source, transceiver 47, a transmitter and/or a receiver may be referred to as an “image source module” or the like.

Processor 21 may be configured to control the operation of the display device 40. The processor 21 may receive data, such as compressed image data from the network interface 27, from camera 800b or from another image source, and process the data into raw image data or into a format that is readily processed into raw image data. The processor 21 may then send the processed data to the driver controller 29 or to frame buffer 28 (or another memory device) for storage.

Processor 21 may control camera 800b according to input received from input device 48. When camera 800b is operational, images captured via light entering substantially transparent area 1010 may be displayed on display 30. Processor 21 may also display stored images on display 30. In some embodiments, camera 800b may include a separate controller for camera-related functions. Processor 21 and any such camera controller may be referred to herein as components of a control system.

In one embodiment, the processor 21 may include a microcontroller, central processing unit (“CPU”), or logic unit to control operation of the display device 40. Conditioning hardware 52 may include amplifiers and filters for transmitting signals to the speaker 45, and for receiving signals from the microphone 46. Conditioning hardware 52 may be discrete components within the display device 40, or may be incorporated within the processor 21 or other components. Processor 21, driver controller 29, conditioning hardware 52 and other components that may be involved with data processing may sometimes be referred to herein as parts of a “logic system,” a “control system” or the like.

The driver controller 29 may be configured to take the raw image data generated by the processor 21 directly from the processor 21 and/or from the frame buffer 28 and reformat the raw image data appropriately for high speed transmission to the array driver 22. Specifically, the driver controller 29 may be configured to reformat the raw image data into a data flow having a raster-like format, such that it has a time order suitable for scanning across the display array 30. Then the driver controller 29 may send the formatted information to the array driver 22.

Although a driver controller 29, such as a LCD controller, is often associated with the system processor 21 as a stand-alone integrated circuit (“IC”), such controllers may be implemented in many ways. For example, they may be embedded in the processor 21 as hardware, embedded in the processor 21 as software, or fully integrated in hardware with the array driver 22. An array driver 22 that is implemented in some type of circuit may be referred to herein as a “driver circuit” or the like.

The array driver 22 may be configured to receive the formatted information from the driver controller 29 and reformat the video data into a parallel set of waveforms that are applied many times per second to the plurality of leads coming from the display's x-y matrix of pixels. These leads may number in the hundreds, the thousands or more, according to the embodiment.

In some embodiments, the driver controller 29, array driver 22, and display array 30 may be appropriate for any of the types of displays described herein. For example, in one embodiment, driver controller 29 may be a transmissive display controller, such as an LCD display controller. Alternatively, driver controller 29 may be a bi-stable display controller (e.g., an interferometric modulator controller). In another embodiment, array driver 22 may be a transmissive display driver or a bi-stable display driver (e.g., an interferometric modulator display driver). In some embodiments, a driver controller 29 may be integrated with the array driver 22. Such embodiments may be appropriate for highly integrated systems such as cellular phones, watches, and other devices having small area displays. In yet another embodiment, display array 30 may comprise a display array such as a bi-stable display array (e.g., a display including an array of interferometric modulators).

The input system 48 allows a user to control the operation of the display device 40. In some embodiments, input system 48 includes a keypad, such as a QWERTY keyboard or a telephone keypad, a button, a switch, a touch-sensitive screen, or a pressure- or heat-sensitive membrane. In one embodiment, the microphone 46 may comprise at least part of an input system for the display device 40. When the microphone 46 is used to input data to the device, voice commands may be provided by a user for controlling operations of the display device 40.

Power supply 50 can include a variety of energy storage devices. For example, in some embodiments, power supply 50 may comprise a rechargeable battery, such as a nickel-cadmium battery or a lithium ion battery. In another embodiment, power supply 50 may comprise a renewable energy source, a capacitor, or a solar cell such as a plastic solar cell or solar-cell paint. In some embodiments, power supply 50 may be configured to receive power from a wall outlet.

In some embodiments, control programmability resides, as described above, in a driver controller which can be located in several places in the electronic display system. In some embodiments, control programmability resides in the array driver 22.

FIG. 11 depicts a method 1100 that may be performed by a lensless camera as provided herein. As with other methods described herein, the steps of methods 1100 and 1200 (see FIG. 12) are not necessarily performed in the order indicated. These methods may include more or fewer steps than are indicated. In some implementations, steps described herein as separate steps may be combined. Conversely, what may be described herein as a single step may be implemented as multiple steps.

In step 1105, an indication is received by a camera controller that a user desires to take a picture. Field of view data are received by the camera controller in step 1110. Depending on the type of lensless camera involved, the indication and field of view data may be received in various ways. For example, if a hand-held device includes the lensless camera, the indication of step 1105 may be received from a shutter button or another user interface on the device. Similarly, the field of view data received in step 1110 may be selected by a user from a user interface.

However, some lensless cameras, such as webcams or security cameras, may be configured for communication with a network. In such embodiments, the indication of step 1105 and/or the field of view data of step 1110 may be received via a network interface. The indication of step 1105 and/or the field of view data of step 1110 may be sent from an operator's device that is also configured for communication with the network. The operator's device may, for example, be a laptop computer, a desktop computer, a mobile device such as a smartphone or iPad™, etc. Accordingly, the operator's device may or may not be in the vicinity of the lensless camera, depending on the particular implementation.

In this example, however, the lensless camera is part of a mobile device such as that described above with reference to FIGS. 10A-10C. The indication of step 1105 is received from a shutter control similar to shutter control 49. Here, the field of view data are received from a touch screen display on which the lensless camera's current field of view is displayed. The touch screen is configured to allow the user to change the field of view by interacting with the touch screen.

In step 1115, the camera controller configures the field of view according to the received field of view data. In some implementations, step 1115 may be performed such a short time after step 1110 that step 1115 may be perceived by a user as occurring at substantially the same time as step 1110: for example, a display device may be displaying the current field of view responsive to the user's input with no apparent delay. There may be multiple iterations of step s 1110 and 1115 as a user selects various possible fields of view.

In this example, the camera controller will perform several additional steps prior to capturing an image. In alternative embodiments, one or more of these steps may be performed prior to step 1110 or step 1115. Here, the camera controller receives ambient light data from an ambient light sensor. (Step 1120.) The camera controller then determines an appropriate shutter speed according to the ambient light data and the size of the “pinhole” formed in array 700b. (Step 1125).

In step 1130, the camera controller determines whether a flash would be appropriate. For example, if the shutter speed determined in step 1125 exceeds a predetermined threshold (such as ½ second, 1 second, etc.), the camera controller may determine that a flash would be appropriate. If so, step 1130 may also involve determining a revised shutter speed appropriate for the additional light contributed by the camera flash, given the size of the “pinhole” formed in array 700b.

In some embodiments, a user may be able to manually override use of the flash. For example, a user may intend to use a tripod or some other means of supporting the camera when a photograph is taken. If so, the user may not want the flash to operate when the picture is taken, even if the shutter will need to be open for a relatively long period of time. Moreover, some lensless camera embodiments do not include a flash. In such embodiments, steps 1130 and 1135 are not performed.

If the camera controller determines in step 1130 that a flash should be used, the camera controller determines appropriate instructions for flash assembly 800 (such as the appropriate timing, intensity and duration of the flash(es) from light source 805) and coordinates the timing of the flash(es) with the operation of shutter array 700c. (Step 1135.) However, if the camera controller determines that a flash will not be used, the camera controller controls a shutter (step 1140) to capture an image is captured on an image sensor (step 1145).

In this example, the image captured in step 1145 is displayed on a display device in step 1150. The image may be deleted, edited, stored or otherwise processed, e.g., according to input received from a user input system. In step 1155, the camera controller will determine whether the process will continue. For example, the camera controller may determine whether input has been received from the user within a predetermined time, whether the user is powering off the camera, etc. In step 1160, the process ends.

FIG. 12 outlines the steps of a method 1200 for automatically tracking a subject using a lensless camera provided herein. In step 1205, a camera controller receives user input indicating that a subject is to be tracked. The camera controller receives subject identification data in step 1210.

Depending on the type of lensless camera involved, the tracking indication and the subject identification data may be received in various ways. For example, if a hand-held device includes the lensless camera, the indication of step 1205 may be received from a user interface on the device. A display device may display images currently being received by the lensless camera. The subject identification data received in step 1210 may, for example, be selected by a user from the display device using a touch screen or other user interface.

However, if the lensless camera is webcam or a security camera, such devices may be configured for communication with a network. The tracking indication of step 1205 and/or the subject identification data of step 1210 may be received via a network interface. The tracking indication of step 1205 and/or the subject identification data of step 1210 may be sent from an operator's device that is also configured for communication with the network. The subject identification data received in step 1210 may, for example, be selected by a user from a display of the operator's device using a touch screen or other user interface. The operator's device may, for example, be a laptop computer, a desktop computer, a mobile device, etc.

In some embodiments, the camera controller may analyze image data received by the lensless camera to determine whether the image includes possible subjects of interest, such as human subjects, animal subjects, or other subjects. In some such embodiments, the camera controller may analyze the image data by applying a face detection algorithm to determine whether the image data are likely to include one or more faces. Possible subjects, such as faces, may be highlighted, outlined and/or otherwise identified in a display. In such embodiments, step 1210 may involve receiving a user's selection, via a user input device, of one or more possible subjects identified by the camera controller. For example, a user may touch an area of a touch screen that corresponds with a possible subject outlined by the camera controller.

Alternatively, or additionally, a user may select, from a display, a subject that has not been previously identified by the camera controller. For example, the user may use an input device to make a circle, a rectangle, etc., around a selected subject's image. Alternatively, the user may touch an area of a touch screen that corresponds with the subject's image. The camera controller may analyze the subject's image to determine identifying characteristics, store these characteristics and use the characteristics to track the subject. In some such embodiments, the camera controller may continue to determine identifying characteristics of the subjects during the tracking process. This continued process may allow for a more reliable subject identification process, in part because a subject may appear different due to changes in perspective, orientation and/or lighting conditions.

The camera controller may then determine an appropriate initial field of view for tracking the subject (step 1215) and configure array 700b accordingly (step 1220). For example, in step 1215 the camera controller may select a field of view in which the subject is approximately centered and in step 1220 the camera controller may configure the array accordingly. If the subject is moving, the camera controller may determine the direction of movement, e.g., relative to the cells of array 700b. In some such embodiments, the camera controller may determine an estimated trajectory of an identified subject relative to the cells of array 700b and/or may determine a estimated velocity (e.g., an angular velocity) of the subject.

In this example, images are then captured on an image sensor. (Step 1225.) The images are displayed on a display device. (Step 1230.) In some embodiments, the display device may be part of the same device that includes the lensless camera. In alternative embodiments, the display device may be part of an operator's device, which may be in communication with the lensless camera over a network.

In step 1235, it will be determined whether a new field of view is required. For example, the camera controller may determine that the tracked subject is nearing the edge of a previously determined field of view. In some such embodiments, the camera controller may determine that the tracked subject has moved to within a predetermined angular range of the edge of a previously determined field of view. In alternative embodiments, the camera controller may determine that the tracked subject has moved to more than a predetermined angle from the center of a previously determined field of view. In some embodiments, the camera controller may determine that a new field of view is required according to input received from a user.

If the camera controller determines that a new field of view is required, the process returns to step 1215 and another field of view is determined. The camera controller may, for example, select a possible field of view according to a predetermined trajectory of the subject and then evaluate the field of view according to a new detected position of the subject. If the subject appears to be changing direction, the camera controller may update a previously estimated trajectory.

If the camera controller determines that a new field of view is not required, the process continues to step 1240, wherein the camera controller determines whether to continue. The process may end (step 1245) for various reasons, such as according to input from a user. In some embodiments, the process may end after a determination that the subject has moved out of any field of view to which array 700b could be configured. In some embodiments, such as surveillance camera embodiments, the lensless camera (or a structure on which the camera is mounted) may be equipped with one or more motors or other such devices. In such embodiments, the lensless camera may be re-oriented automatically and/or in response to a command from an operator's device. Such embodiments increase the angular range through which a subject may be tracked.

Although illustrative embodiments and applications are shown and described herein, many variations and modifications are possible which remain within the concept, scope, and spirit of what has been provided herein, and these variations should become clear after perusal of this application. For example, alternative MEMS devices and/or fabrication methods such as those described in U.S. application Ser. No. 12/255,423, entitled “Adjustably Transmissive MEMS-Based Devices” and filed on Oct. 21, 2008 (which is hereby incorporated by reference) may be used. Accordingly, the present embodiments are to be considered as illustrative and not restrictive, and the invention is not to be limited to the details given herein, but may be modified within the scope and equivalents of the appended claims.

We claim:

1. A lensless camera, comprising:
a light sensor;
an interface configured to receive a field of view indication;
an array of microelectromechanical systems (“MEMS”) devices configured to block incoming visible light from reaching the light sensor when the MEMS devices are in a first position and to transmit incoming visible light to the light sensor when the MEMS devices are in a second position; and
a control system configured to do the following:
receive a field of view indication from the interface;
determine a transmissive area in the array of MEMS devices corresponding with the field of view indication;
control MEMS devices in the transmissive area to be in the second position; and
drive other MEMS devices of the array to the first position.

2. The lensless camera of claim 1, wherein the interface comprises a user interface.

3. The lensless camera of claim 1, wherein the interface comprises a network interface and wherein the control system is configured to control the lensless camera, at least in part, according to signals received via the network interface.

4. The lensless camera of claim 1, further comprising a display device, wherein the control system is further configured to control the display device to display image data from the light sensor.

5. The lensless camera of claim 1, wherein the control system is further configured to receive subject identification data from the interface and to control the array to track a subject according to the subject identification data.

6. The lensless camera of claim 1, wherein the control system is further configured to analyze image data received by the light sensor to determine whether the image data indicate possible subjects.

7. A mobile device that includes the lensless camera of claim 1.

8. The lensless camera of claim 4, wherein the interface comprises a user interface, wherein the display device comprises part of the user interface and wherein the control system is further configured to control the display device to indicate a current field of view.

9. The lensless camera of claim 5, further comprising a display device, wherein the interface comprises a user interface and wherein the subject identification data comprise image data from a portion of an image displayed on the display device.

10. The lensless camera of claim 5, wherein the interface comprises a network interface and wherein the subject identification data comprise image data from a portion of an image displayed on an operator's display device.

11. The lensless camera of claim 6, further comprising a display, wherein the control system is further configured to indicate possible subjects on the display.

12. The mobile device of claim 7, wherein the mobile device is configured for data and voice communication.

13. The lensless camera of claim 11, wherein the interface comprises a user interface and wherein the control system is further configured to receive a user's selection of one of the possible subjects indicated on the display.

14. The lensless camera of claim 13, wherein the user interface comprises a touch screen display and wherein the control system controls the touch screen display to indicate the possible subjects.

15. A lensless camera, comprising:
light-sensing means for sensing light;
interface means configured to receive a field of view indication;
array means for blocking incoming visible light from reaching the light-sensing means when the array means is in a first configuration and to transmit incoming visible light to the light-sensing means when the array means is in a second configuration; and
control means for:
receiving a field of view indication from the interface means;
determining a transmissive area in the array means corresponding with the field of view indication;
controlling MEMS devices in the transmissive area to be in the second configuration; and
driving other MEMS devices of the array means to the first configuration.

16. The lensless camera of claim 15, wherein the interface means comprises a user interface.

17. The lensless camera of claim 15, wherein the interface means comprises a network interface and wherein the control means is configured to control the lensless camera, at least in part, according to signals received via the network interface.

18. The lensless camera of claim 15, wherein the control means is further configured to receive subject identification data from the interface means and to control the array means to track a subject according to the subject identification data.

19. A method, comprising:
receiving a field of view indication for a lensless camera;
determining a pinhole location for the lensless camera corresponding with the field of view indication;
controlling an array of microelectromechanical systems (“MEMS”) devices to form a transmissive area in an array location corresponding to the pinhole location and to make the remaining MEMS devices of the array substantially non-transmissive in the visible spectrum; and
capturing an image from light passing through the transmissive area.

20. The method of claim 19, wherein the receiving process comprises receiving the field of view indication from a user interface of the lensless camera.

21. The method of claim 19, wherein the receiving process comprises receiving the field of view indication from a network interface of the lensless camera.

22. The method of claim 19, further comprising:
receiving subject identification data; and
controlling the array to track a subject according to the subject identification data.

23. The method of claim 19, further comprising:
analyzing image data received during the capturing process; and
determining whether the image data indicate possible subjects.

24. The method of claim 19, further comprising controlling a display to indicate a current field of view.

25. The method of claim 23, further comprising indicating the possible subjects on a display.
